(19) United States
(12) Patent Application Publication
(10) Pub. No.: US 2008/0163453 A1
(43) Pub. Date: Jul. 10, 2008

(54) BUSHING FOR SUSPENSION SYSTEM

(76) Inventor: JERRY JOSEPH, Woodcliff, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/621,237

(22) Filed: Jan. 9, 2007

(51) Int. Cl. F16F 1/38

(52) U.S. Cl. 16/2.1

(57) ABSTRACT

A bushing is provided for use in an automotive suspension system. The bushing is formed as a monolithic structure having a proximal flange and a distal flange located proximal to a distal end of the bushing. The bushing defines a bore having a contact patch for engagement with an anti-sway bar component of the suspension system. The distal flange of the bushing is provided with radial cut outs to facilitate insertion of the bushing in a mounting flange of the suspension system. The bushing also includes longitudinally extending ribs to align the bushing within the mounting hole during installation.

### BACKGROUND

1. Technical Field

The present disclosure relates to a bushing for use in an automobile suspension system. More particularly, the present disclosure relates to a monolithic bushing for use in supporting an anti-sway bar component of an automobile suspension system.

2. Background of Related Art

Automobiles or automotive vehicles incorporate various components configured to control and stabilize the vehicle during operation. For example, steering components are provided to steer the vehicle around turns, etc. As a vehicle passes or corners through a turn, the body of the vehicle tends to continue in a straight line and rolls or leans toward the outside of the turn due to the forces of inertia acting on the body of the vehicle.

Modern vehicles often incorporate stabilizing or “anti-sway” bars to counteract the forces of inertia in order to reduce the roll or lean of the vehicle as it passes through a turn. The anti-sway bars accomplish this by stiffening the suspension components and redistributing the forces, exerted on the suspension, from one side of the suspension system to the other. By balancing out the forces acting on the vehicle, the vehicle can pass through the turn with much less lean or body roll.

Anti-sway bars may be incorporated in the front and/or rear suspension system of the subject vehicle. They typically extend from one side of the vehicle to the other and are connected at their ends to respective components, such as linkages, of the suspension system. Portions of the anti-sway bars are connected to, and supported by, frame components of the vehicle in order to redistribute the forces acting on the body of the vehicle. The anti-sway bars are supported in the frame by bushings which allow a small amount of movement of the anti-sway bar relative to the frame to prevent breakage of the anti-sway bar as it flexes during the balancing of the forces on the body of the vehicle. However, too much movement between the anti-sway bar and the frame lessens the effect of the anti-sway bar on the body of the vehicle.

Current bushings used to support anti-sway bars are typically multi-component affairs subject to fatigue and failure. An outer sleeve supports a central core which can separate from the sleeve over time. The central core of the bushing is formed of a rubber compound which maintains a minimal grip on the anti-sway bar and is subject to compression problems due to the poor memory, or ability to retain to shape, of the rubber compound. This can result in annoying, and possibly dangerous, loose interaction or slapping noises coming out of the components, as well as, a lessening of the life span of the anti-sway bar and, more importantly, of the bushing supporting the anti-sway bar relative to the frame of the vehicle.

Therefore, it is desirable to provide a bushing for use with an anti-sway bar system of an automobile suspension system which is capable of retaining its shape over a long period of time. It is further desirable to provide a single piece, or “monolithic” bushing not prone to component separation and capable of providing a greater area of support for an associated anti-sway bar component of an automobile suspension system.

### SUMMARY

There is disclosed a bushing for use in an automobile suspension system. The bushing is in the form of a cylinder having a proximal end portion, a distal end portion and a central portion extending between the proximal end portion and the distal end portion. The cylinder defines a central bore extending from a proximal end of the cylinder to a distal end of the cylinder for receipt of an anti-sway bar component of an automotive suspension system. A first circumferential flange projects outwardly from the proximal end portion of the cylinder and a second circumferential flange projects outwardly from the distal end portion. The second circumferential flange is remote from the distal end of the cylinder.

The central portion has an arcuate outer surface which forms a contact patch with a mounting hole in a mounting flange of the suspension system. The central bore has an inner surface having a leadin surface, a central portion and a leadout surface. The central portion forms a contact patch with the anti-sway bar of the suspension system. The contact patch extends substantially the length of the central bore. The leadin surface forms a predetermined angle greater than 0° with the central portion.

In one embodiment the first flange has a chamfered edge and the second flange has a chamfered edge. In a further embodiment, the distal end portion includes at least one longitudinal cut while the second flange includes at least one radial cut. The distal end portion additionally includes at least one longitudinally extending rib to align the bushing within a mounting hole.

The cylinder is preferably formed from polyurethane as a monolithic structure. In one embodiment the cylinder is formed by injection molding.

There is also disclosed a bushing for use in an automobile suspension system having a cylinder including a proximal end portion, a distal end portion and a central portion extending between the proximal end portion and the distal end portion. A central bore extends from a proximal end of the cylinder to a distal end of the cylinder for receipt of a component of a suspension system. The central bore has a leadin portion, a central portion defining a contact patch with an anti-sway bar of the suspension system and a leadout portion.

A first circumferential flange projects outwardly from the proximal end portion of the cylinder and a second circumferential flange projects outwardly from the distal end portion. The second circumferential flange is remote from the distal end of the cylinder and includes at least one radial cut. The distal end portion includes at least one longitudinal cut and at least one longitudinal rib.

### DESCRIPTION OF THE DRAWINGS

An embodiment of the presently disclosed monolithic anti-sway bar bushing is described herein with reference to the drawings, wherein:

FIG. 1 is a perspective view of a prior art type anti-sway bar bushing installed in an automobile suspension system;

FIG. 1a is an enlarged, expanded view of the prior art bushing installation of FIG. 1;

FIG. 1b is a cross-sectional view of the prior art bushing installation taken along line I-I of FIG. 1;

FIG. 2 is an expanded, perspective view of the presently disclosed monolithic anti-sway bar bushing and associated automobile suspension components;

FIG. 2a is a distal end view of the monolithic bushing of FIG. 2;

FIG. 2b is an enlarged area of detail view of the monolithic bushing taken at area II of FIG. 2; and

FIG. 2c is a cross-sectional view of the disclosed monolithic bushing installed in an automobile suspension system.

### DETAILED DESCRIPTION OF A PREFERRED EMBODIMENT

An embodiment of the presently disclosed anti-sway bar bushing will now be described in detail with reference to the drawings wherein like numerals designate identical or corresponding elements in each of the several views. As is common in the art, the term “proximal” refers to that part or component closer to the user, while the term “distal” refers to that part or component further away from the user.

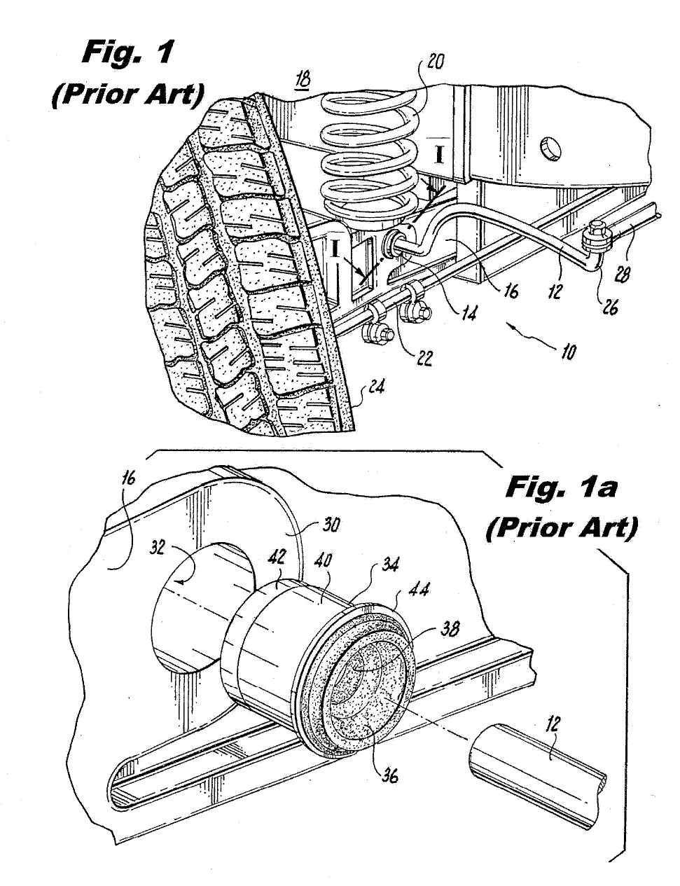

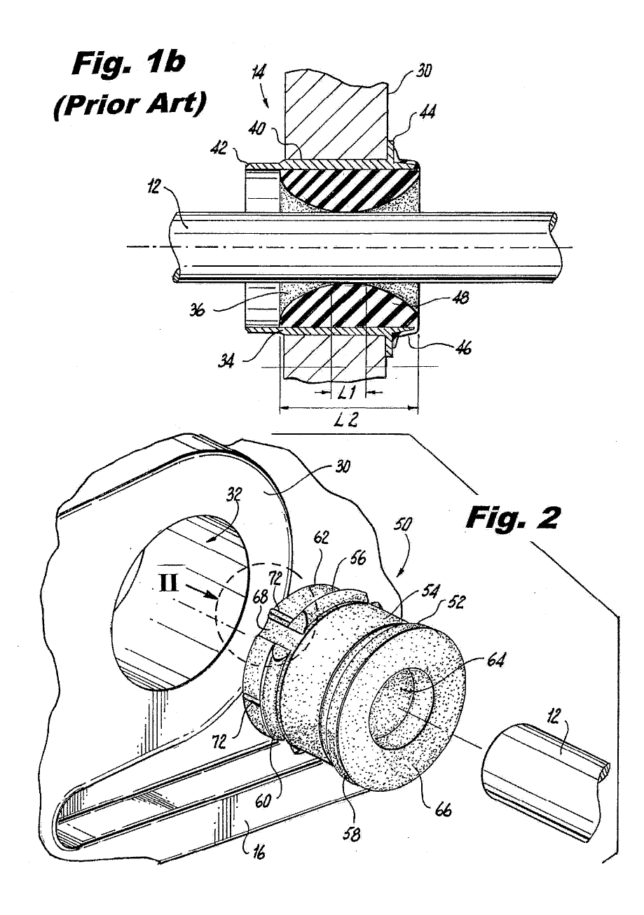

Referring initially to FIG. 1, there is illustrated one side of an automotive suspension system 10 incorporating an anti-sway bar 12 and a typical, prior art bushing 14 mounting anti-sway bar 12 on a frame 16 of an associated vehicle 18. Suspension system 10 additionally includes a spring 20 to soften the ride of vehicle 18. A tie rod 22 is connected to a tire 24 and forms part of the steering system of vehicle 18. As shown, an end 26 of anti-sway bar 12 is connected to a stabilizer bar linkage associated with suspension system 10.

Referring now to FIG. 1a, frame 16 includes a mounting flange 30 defining a mounting hole 32 for receipt of prior art bushing 14. Prior art bushing 14 generally includes an outer sleeve 34 partially housing a flexible inner core 36. Outer sleeve 34 is formed from a metallic material while flexible inner core 36 is typically formed of a rubber compound. Inner core 36 is affixed to outer sleeve 34 by an adhesive or other means of securement such as, for example, welding or molding inner core 36 within outer sleeve 34.

Inner core 36 defines a bore 38 for receipt of anti-sway bar 12. When assembled within suspension system 10, outer sleeve 34 contacts frame 16 and anti-sway bar 12 contacts an inner surface of bore 38 in inner core 36.

Referring to FIGS. 1a and 1b, outer sleeve 34 includes a central portion 40 having a distal stepped down portion 42 and a proximal flange 44. Central portion 40 contacts the inner surface of mounting hole 32 in mounting flange 30 of frame 16 while proximal flange 44 abuts mounting flange 30 to maintain prior art bushing 14 in position within mounting hole 32 of mounting flange 30. Distal stepped down portion 42 facilitates insertion of prior art bushing 14 into mounting hole 32.

As best shown in FIG. 1b, inner core 36 has a proximal lip 46 of material molded about proximal flange 44 of outer sleeve 24 due to the assembly process. More importantly, bore 38 of inner core 36 has an arcuate inner surface 48 which contacts anti-sway bar 12. Forming inner surface 38 with an arcuate shape provides for a large degree of flexion of anti-sway bar 12 relative to prior art bushing 14 but only allows for a minimal amount of contact between inner core 36 and anti-sway bar 12. Specifically, only a small distance L1 of inner surface 48 actually contacts anti-sway bar 12. Typically, distance L1 is approximately less than one third of the overall length L2 on inner surface 48 of bore 38 in inner core 36.

The construction materials and configuration of prior art bushing 14 lead to multiple problems. First, as noted above, anti-sway bar continually moves relative to prior art bushing 14 thereby exerting repeated forces on prior bushing 14. Being made of a metallic substance, outer sleeve 34 is subject to stress fractures. The rubber compound forming inner core 36 is subject to compaction and resultant loss of contact with anti-sway bar 12, as well as, being subject to deterioration due to exposure to environmental conditions, such as, exposure to fuels, oils, etc. These situations can lead to loss of contact with mounting flange 30 and anti-sway bar 12 causing steering problems, as well as, annoying slapping noises, etc.

Importantly, by forming prior art bushing in two parts and of dissimilar materials, inner core 36 can, in some circumstances, separate from outer sleeve 34 resulting in a dangerous situation. The end result of all of these situations is a constantly weakening connection between prior art bushing 14 and anti-sway bar 12 and mounting flange 30 leading to a relatively small useful life span for prior art bushing 14.

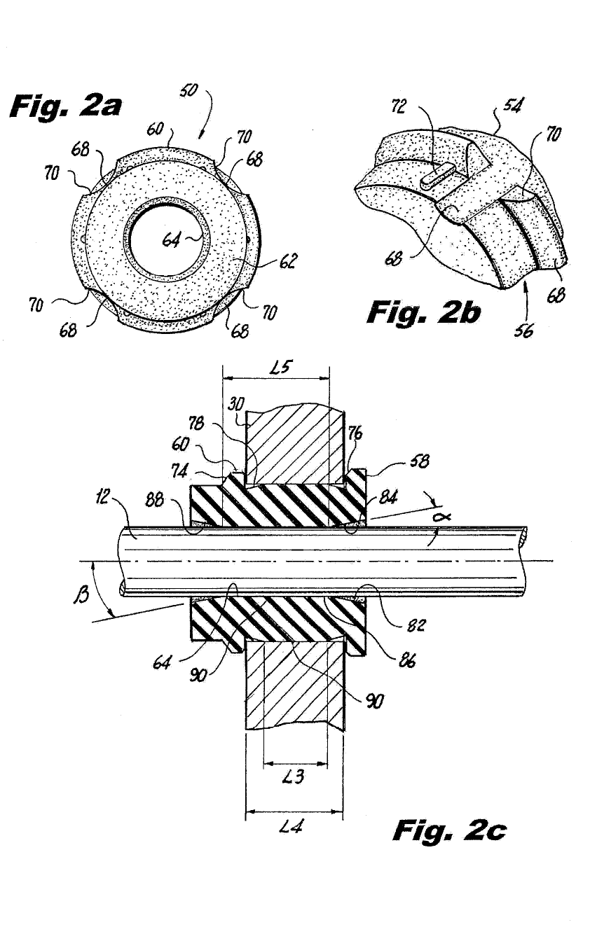

Referring now to FIGS. 2-2c, and initially with regard to FIG. 2, there is disclosed a novel bushing 50 for use in automotive suspension system 10 which does away with or completely eliminate the problems associated with prior art bushing 13. Bushing 50 is formed from a single material as a unitary or monolithic structure. Preferably, bushing 50 is formed from a polyurethane material. Polyurethane materials have ideal characteristics for use in novel bushing 50. Polyurethane materials have excellent “memory” or ability to repeatedly return to the original shape. The material does not “set” or compress and lose shape during repeated flexions thereby substantially increasing bushing 50's useful life span. Further, certain polyurethane materials are not subject to the same environmental degradation factors as the rubber compounds used in prior art bushing 14.

As noted above, bushing 50 is formed as a single, monolithic structure thereby eliminating any possibility of component separation. Preferably, bushing 50 is formed using an injection molding process. However, other methods of forming bushing 50 are contemplated herein, for example, forming hardened polyurethane on a lathe, etc. Further advantages of forming bushing 50 as a monolithic structure are lower manufacturing costs, more precise manufacturing tolerances, ease of installation, etc.

Bushing 50 generally includes a proximal portion 52, a central portion 54 and a distal portion 56. A radially extending, circumferential first flange 58 is formed on proximal portion to secure bushing 50 against one side of mounting flange 30. Distal portion 56 includes a radially extending, circumferential second flange 60 formed proximally from a distal end 62 of bushing 50. Second flange 60 secures bushing 50 against an opposite side of mounting flange 30 to prevent bushing 50 from “pulling out” of mounting hole 32 in mounting flange 30 due to forces exerted on bushing 50.

Bushing 50 defines a central bore 64 for receipt of anti-sway bar 12. Central bore 64 extends from a proximal end 66 of bushing 50 to distal end 62 of bushing 50.

Referring now to FIGS. 2, 2a and 2b, in order to facilitate installation of bushing 50 within mounting hole 36 in mounting flange 30, distal portion 56 is provided with a plurality of radially spaced, longitudinal cuts 68. Longitudinal cuts 68 allow distal portion 56 to flex or compress inwardly as bushing 50 is driven into mounting hole 32. Bushing 50 can be installed into mounting hole 32 using a special insertion tool or simply pounded or driven by a mallet. The unique characteristics of the polyurethane material of bushing 50 allow bushing 50 to resume its shape without any permanent damage to bushing 50. As shown, distal portion 56, and specifically second flange 60, may be provided with a series of circumferentially spaced, radial cuts formed in second flange 60 to facilitate passage of second flange 60 through mounting hole 32 in mounting flange 30.

Referring for the moment to FIGS. 2 and 2b, distal portion 56 may additionally include a series of circumferentially spaced, radially projecting longitudinal ribs 72. Longitudinal ribs 72 aid in aligning distal portion 56 within mounting hole 32 as bushing 50 is initially inserted into mounting hole 32.

Referring now to FIG. 2c, in order to further facilitate installation of bushing 50 in mounting hole 32 of mounting flange 30, second flange 60 has a leading chamfered edge 74. Likewise, in order to facilitate removal of bushing 50 at the end of its useful life or in the case of damage due to accident, etc., first flange 58 has a leading chamfered edge 76. Chamfered edges 74 and 76 facilitate movement of second and first flanges 60 and 58, respectively, through mounting hole 32.

Central portion 54 has a slightly arcuate outer surface 78 which contacts mounting hole 32 in mounting flange 30. A portion of arcuate outer surface 78 forms a first contact patch 80 configured to engage and grip mounting hole 32. First contact patch 80 has a length L3 extending substantially the length L4 of outer surface 78 for maximum engagement with mounting hole 32.

Central bore 64 of bushing 50 has an inner surface 82 forming a leadin surface 84, a central surface portion 86 and a readout surface 88. Leadin surface 84 and leadout surface 88 are oriented at an angle α relative to central surface portion 86. This allows anti-sway bar 12 to move or “wobble” through an angle β relative to a center line A-A of central bore 64 and prevent bending of anti-sway bar 12.

As shown, central surface portion 86 forms a second contact patch 90 engaging anti-sway bar 12. In contrast to the relatively short length L1 of inner surface 48 of bore 38 in prior art bushing 14, contact patch 90 has a length L5 which extends substantially the length of central bore 64 and greatly exceeds that of L1 of prior art bushing 14. Thus, bushing 50 maintains a much greater area of contact with anti-sway bar 12 than prior art bushing 14 while still allowing anti-sway bar 12 to move or “wobble” within bushing 50.

It will be understood that various modifications may be made to the embodiment disclosed herein. For example, the second or distal flange may be positioned closer to the distal end of the disclosed bushing to provide clearance for movement of other components of the suspension system. Further, the central portion of the disclosed bushing need not be arcuate but may be completely flush with the anti-sway bar. Additionally, the first or proximal flange may also be provided with cuts to facilitate movement of the proximal flange through the mounting hole in the mounting flange during removal of the bushing. Therefore, the above description should not be construed as limiting, but merely as exemplifications of particular embodiments. Those skilled in the art will envision other modifications within the scope and spirit of the claims appended hereto.

1. A bushing for use in an automobile suspension system comprising:
a cylinder having a proximal end portion, a distal end portion and a central portion extending between the proximal end portion and the distal end portion, the cylinder defining a central bore extending from a proximal end of the cylinder to a distal end of the cylinder for receipt of a component of a suspension system;
a first circumferential flange projecting outwardly from the proximal end portion of the cylinder; and
a second circumferential flange projecting outwardly from the distal end portion, the second circumferential flange being remote from the distal end of the cylinder.

2. The bushing as recited in claim 1, wherein the central portion has an arcuate outer surface.

3. The bushing as recited in claim 2, wherein the arcuate outer surface forms a contact patch with a mounting hole in a mounting flange of the suspension system.

4. The bushing as recited in claim 1, wherein the central bore has an inner surface having a leadin surface, a central portion and a leadout surface.

5. The bushing as recited in claim 4, wherein the central portion forms a contact patch with an anti-sway bar of the suspension system.

6. The bushing as recited in claim 5, wherein the contact patch extends substantially the length of the central bore.

7. The bushing as recited in claim 4, wherein the leadin surface forms a predetermined angle greater than 0° with the central portion.

8. The bushing as recited in claim 1, wherein the first flange has a chamfered edge.

9. The bushing as recited in claim 1, wherein the second flange has a chamfered edge.

10. The bushing as recited in claim 1, wherein the distal end portion has at least one longitudinal cut.

11. The bushing as recited in claim 1, wherein the second flange has at least one radial cut.

12. The bushing as recited in claim 1, wherein the distal end portion includes at least one longitudinally extending rib.

13. The bushing as recited in claim 1, wherein the cylinder is formed from polyurethane.

14. The bushing as recited in claim 1, wherein the cylinder is monolithic.

15. The bushing as recited in claim 1, wherein the cylinder is formed by injection molding.

16. A bushing for use in an automobile suspension system comprising:
a cylinder having a proximal end portion, a distal end portion and a central portion extending between the proximal end portion and the distal end portion:
a central bore extending from a proximal end of the cylinder to a distal end of the cylinder for receipt of a component of a suspension system the central bore having a leadin portion, a central portion defining a contact patch with an anti-sway bar of the suspension system and a leadout portion;
a first circumferential flange projecting outwardly from the proximal end portion of the cylinder; and
a second circumferential flange projecting outwardly from the distal end portion, the second circumferential flange being remote from the distal end of the cylinder and including at least one radial cut.

17. The bushing as recited in claim 16, wherein the distal end portion includes at least one longitudinal cut.

18. The bushing as recited in claim 16, wherein the distal end portion includes at least one longitudinal rib.
